(19) United States
(12) Patent Application Publication
(10) Pub. No.: US 2003/0145793 A1
(43) Pub. Date: Aug. 7, 2003

(54) Clear fluid enclosed in sealed clear plastic for light-based fly repellent

(76) Inventors: Jack Mathews, Washington, MI (US); John Ronald White, Columbus, NC (US)

Correspondence Address: Jack Mathews, 57169 Willow Way, Washington, MI, 48094, US

(21) Appl. No.: 10/068,648

(22) Filed: Feb. 5, 2002

(51) Int. Cl. A01K 29/00

(52) U.S. Cl. 119/6.5

(57) ABSTRACT

A clear plastic container holding a clear fluid that repels houseflies by refracting light. The container may be a hard or soft plastic.

### CROSS-REFRENCE TO RELATED APPLICATIONS

Not applicable.

### BACKGROUND

1. Field of Invention

This invention relates to the use of a clear fluid encapsulated in clear plastic as a means of refracting light to repel the common housefly and members of the common housefly (Musca domestica) family.

2. Description of Prior Art

Open-air spaces are easily infested with flies. Fly infestation can lead to transmission of disease agents from fly to humans. It has been shown that each housefly can easily carry over one million bacteria on its body. Some of the disease-causing agents shown to be transmitted by house flies to humans are: shigella spp., salmonella spp., Escherichia coli, and Vibrio comma. To ward off flies, consumers have had the following options: chemicals, traps, and sound devices. Each option has serious disadvantages.

Examples of chemical options include Raid ®, Black Flag®, Exciter, Vapona, and Purge III. Chemical options are insecticides that usually act both as repellent and exterminator. The active ingredient in chemical fly repellents/exterminators are typically Pyrethin, Malathion, Permethrin, DDVP, and Cypermethrin. Chemical based repellents/exterminators has several disadvantages:

a) It introduces a toxin into to the environment. Chemical based repellents/exterminators are typically broad band. Depending upon the active agent(s), they can potentially harm and/or repel beneficial insects, beetles, birds, etc.

b) Chemical based repellents/exterminators may build up and remain in the environment, creating unforeseen, long-term problems.

c) Chemical based repellents/exterminators tend to have an unpleasant odor.

d) Chemical based repellents/exterminators have a limited time frame for effectiveness.

e) Chemical based repellents marketed as “natural” products, such as citronella, are typically very limited in their practical effectiveness.

Examples of traps include Vector Fly System, Gold Stick Trap, and Advantage Fly Trap. Chemical based traps use chemical agents to lure flies to a trapping device. The device may be separate from the chemical lure, or combined with the chemical lure. A trapping device with a trapping device separate from a chemical lure will rely on the trapping device's design to prevent the fly from reentering the surrounding environment. This form of trap has several disadvantages:

a) Although the intent of the chemical lure is not to disperse into the environment, a natural dispersal may occur, depending on the nature of the chemical.

b) The attractive effect of the chemical lure is of limited duration. When the chemical lure ceases to be effective, the consumer typically is not able to replace the lure, leading to unnecessary additional physical waste and expense.

c) Depending on the design of the physical trapping method, this form of trap will tend to allow some of the trapped flies to escape back into the environment.

d) The ultimate consequence and effect of the trap is to kill the trapped flies.

Traps with a chemical lure combined with a trapping agent are typically a form of “sticky paper” such as Vector Fly System. This form of trap has the following disadvantages:

a) Although the intent of the chemical lure and trapping agent is not to disperse into the environment, a natural dispersal may occur, depending on the nature of the chemical.

b) The intended effect of the trap produces an unattractive result (i.e. a strip of dead flies).

c) The intended effect of the trap produces an unsanitary result (i.e. a strip of decaying flies).

d) The duration of the trap's effectiveness is limited to the free space available on the trap's treated surface(s); its effectiveness diminishes at a rate directly proportional to its covered surface(s).

Traps that employ a non-chemical based lure and kill technique typically rely on an electric charge. This form of trap has the following disadvantages:

a) Traps based on an electric charge are limited to locations with access to an electric current.

b) Traps based on an electric charge are more expensive to purchase, run, and maintain than other form of traps and repellents.

c) Traps based on an electric charge are visually unattractive and create noise pollution.

d) The light-based lure for electric lure and kill devices is limited in its effectiveness on houseflies.

e) Electric lure and kill devices kill flying insects, moths, beetles, etc. indiscriminately.

Other forms of repellent uses sound waves at a range of frequency inaudible to the human ear to drive away insects, beetles, spiders, etc. from an area. This form of repellent has the following disadvantages:

a) Sound-based repellents have a very limited and specific range.

b) Sound-based repellents work best in contained areas.

c) Sound-based repellents require an electric current in order to function.

d) Sound-based repellents operate against a broad-band of insects.

### SUMMARY

The present invention uses a clear fluid encapsulated in clear plastic as a means of refracting light to repel the common housefly and members of the house fly family (Musca domestica) through the creation of optical disturbances.

### OBJECTS AND ADVANTAGES

The objects and advantages of the present invention include the following:

a) provides a non-toxic form of repelling flies, including, by refracting light and disturbing their optical perception;

b) repels flies in outside areas; provides an effective, non-toxic barrier to flies at building entrances and/or windows;

c) provides repelling action across a narrow-band, limited to the common house fly];

d) is entirely inert, creating no environmental dispersion or contamination;

e) does not rely on an electrical current to function;

f) is aesthetically pleasing;

g) does not kill flies, etc., only repels them;

Additional objects and advantages are to provide an effective yet ecologically sound form of fly repellent that is inexpensive for the consumer and simple in its operation. Further objects and advantages will become apparent from a consideration of the following description and drawings.

### DRAWING FIGURES

In the drawings, FIG. 1 shows a surface or table top device, with a hard closed clear plastic chamber, cap, and sealant.

FIG. 2 shows a hanging device, with a closed clear soft plastic chamber and mounting hole.

### REFERENCE NUMERALS IN DRAWINGS

10 hard plastic chamber

12 cap

14 sealed groove

16 mounting hole

18 plastic lip

20 soft plastic chamber

### DESCRIPTION—FIGS. 1 and 1

FIG. 1 represents a surface or table top device. It is constructed of hard clear plastic and filled with distilled water. The dimensions are the following: 10″ height, 4″ width, 4″ depth. The base is the device's cap, which is sealed.

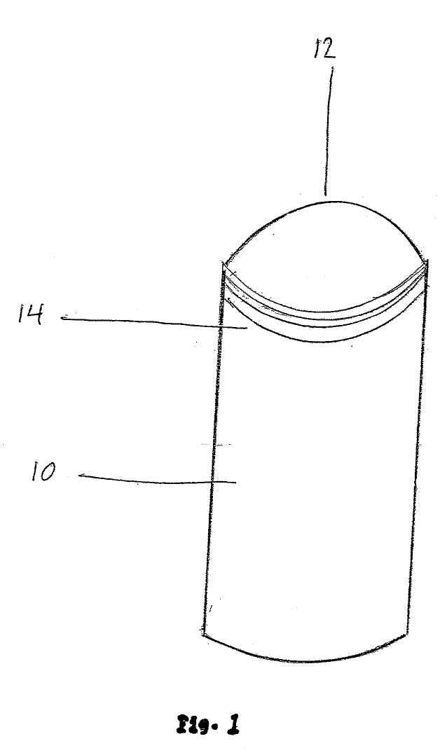

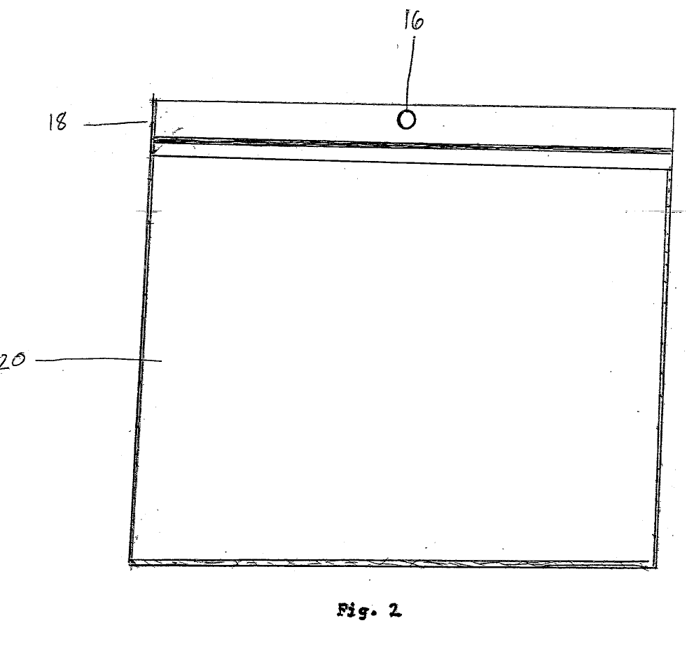

FIG. 2 represents a hanging device. It is constructed of soft clear plastic and filled with distilled water. The top side contains a plastic lip. The top plastic lip has a mounting hole directly in its center. The dimensions are the following: 12″ height, 12″ width, ½″ depth.

Advantages

From the description above, a number of advantages of this fly repelling device become evident:

(a) It is constructed of environmentally friendly components (i.e. distilled water and recyclable plastic.

(b) It is entirely inert and non-toxic.

(c) It is ecological and maintains environmental balance, as it neither traps nor kills houseflies but causes them to avoid the targeted area.

(d) It is light, small, and mobile.

(e) It is aesthetically pleasing to the eye.

Operation

The FIG. 1 device is placed in the center of an area which one desires to be free of houseflies. It must be unobstructed from light, and should be placed at approximately waist level. The passage of light through the container refracts the sunlight in such a manner that it disturbs the flies optical perception, and effectively repels them.

The FIG. 2 device is suspended with a light line such as fishing tackle. It can be placed in front of door openings and/or around areas. The passage of light through the container refracts the sunlight in such a manner that it disturbs the flies optical perception, and effectively repels them.

Conclusion, Ramifications, and Scope

Accordingly, the reader will see that this form of fly repelling device can be used in a safe, environmentally-friendly manner to temporarily rid an area of houseflies. Its advantages over all prior art include the following:

provides a non-toxic form of repelling flies, including, by refracting light and disturbing their optical perception;

repels flies in outside areas;

provides an effective, non-toxic barrier to flies at building entrances and/or windows;

provides repelling action across a narrow-band, limited to the common house fly];

is entirely inert, creating no environmental dispersion or contamination;

does not rely on an electrical current to function;

is aesthetically pleasing;

is constructed of reusable and recyclable materials; and

maintains environmental balance by temporarily relocating houseflies rather than killing or trapping them.

Although the description above contains a number of specifications, these should not be construed as limiting the scope of the invention but as merely providing illustrations of some of the presently preferred embodiments of the invention. For example, the chamber can have other shapes, such as circular, oval, triangular, etc.; the fluid contained in the device need not be distilled water, but can be any clear fluid, such as methyl alcohol, purified water, hydrogen peroxide, etc.

Thus, the scope of the invention should be determined by the appended claims and their legal equivalents, rather than the examples given.

I claim:

1. A method for repelling the common house fly and members of the house fly family comprising refracting light through a clear liquid encapsulated in a sealed, clear plastic container.
